(19) United States
(12) Patent Application Publication
(10) Pub. No.: US 2007/0214370 A1
(43) Pub. Date: Sep. 13, 2007

(54) Portable terminal

(75) Inventors: Jun Sato, Kawasaki-shi (JP); Toru Terauchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/497,733

(22) Filed: Aug. 2, 2006

(30) Foreign Application Priority Data
Mar. 7, 2006 (JP) 2006-060986

(51) Int. Cl. H04L 9/32; H04L 9/00; G06F 12/14; G06F 17/30; G06F 7/04; G06F 11/30; G06K 9/00; H03M 1/68; H04K 1/00; H04N 7/16

(52) U.S. Cl. 713/193; 726/27; 713/165; 713/167

(57) ABSTRACT

A portable terminal capable of encrypting a content and connectable to a module and removable memory card which stores an encrypted content, comprising an ID combination part configured to generate a combination ID by combining a device ID of the portable terminal and a device ID of at least the one module, and an encryption key generation part configured to generate an encryption key by using the combination ID generated from the ID combination part.

### CROSS-REFERENCE TO RELATED APPLICATIONS

This application is based upon and claims the benefit of priority from prior Japanese Patent Application No. 2006-060986, filed Mar. 7, 2006, the entire contents of which are incorporated herein by reference.

### BACKGROUND OF THE INVENTION

1. Field of the Invention

This invention relates to a portable terminal which can hold a memory card. More specifically, the invention relates to a portable terminal that can hold a variety of modules in addition to the memory card.

2. Description of the Related Art

A portable terminal possible to hold the memory card has become widely used. For instance, in a cellular phone and a personal digital assistant (PDA), the memory card has been used as an external storage means for data sometimes. The portable terminal allows extraction/insertion of the memory card therefrom/thereto, so that if a user prepares a lot of memory cards, the user can store a variety of items of data indefinitely. Furthermore, with the increase in the capacity of the memory card, the portable terminal with a memory card slot mounted thereon has become possible to download a large volume of content. A variety of types of the memory cards have appeared on a market, and an SD memory card has been used as one of them. A copy protection for recordable media (CPRM) technique is incorporated as a copyright protection technique in the SD memory card as a standard. The SD memory card then can encrypt to store content data to be stored therein.

A content information storing method and a content information processor in a content information encryption system capable of safely transferring (moving) data among media of users while blocking illegal copy of distributed data by using such a scheme described above are proposed (patent document: Jpn. Pat. Appln. KOKAI Publication No. 2000-305853). This patent document discloses a technique to encrypt content by using a media ID.

When achieving device bind and user bind in use of such a CPRM for SD-Binding system mentioned above, the portable terminal usually uses information unique to a device such as a device ID attached to the main body of the portable terminal, a value derived from a telephone number for which a subscription is made by the user, and the like, and brings them together with information proper to the SD memory card to encrypt a title key. However, in this case, if the device ID, the value derived from the telephone number for which the subscription is made by the user, and the like has been come out, the possibility that the portable terminal is hacked and contents of targets of copyright protection are flowed out is large.

### BRIEF SUMMARY OF THE INVENTION

An object of the present invention is to provide a portable terminal reducing a risk of hacking of copyright-protected contents.

As a form capable of adding a function module to configure one portable terminal thereby, when it is presumed that a main body of one portable terminal is one of modules, in the case that the portable terminal is composed of a plurality of modules, a cryptographic key is generated by combining device IDs added for each module and a title key is encrypted by using the cryptographic key. A method for combining these pluralities of device IDs are decided at random.

A portable terminal capable of encrypting a content and connectable to a module and removable memory card which stores an encrypted content, according to one aspect of the invention is characterized by comprising: an ID combination part configured to generate a combination ID by combining a device ID of the portable terminal and a device ID of at least the one module; and an encryption key generation part configured to generate an encryption key by using the combination ID generated from the ID combination part.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary view for explaining a schematic configuration and a flow of data to be protected by a CPRM for SD-Binding technique of a portable terminal regarding an embodiment of the present invention;

FIG. 2 is an exemplary view for explaining a schematic configuration and a flow of data to be protected by the CPRM for SD-Binding technique of a portable terminal regarding a first embodiment of the present invention; and

FIG. 3 is an exemplary view for explaining a schematic configuration and a flow of data to be protected by the CPRM for SD-Binding technique of a portable terminal regarding a second embodiment of the present invention.

### DETAILED DESCRIPTION OF THE INVENTION

Embodiments of the present invention will be described with reference to the drawings.

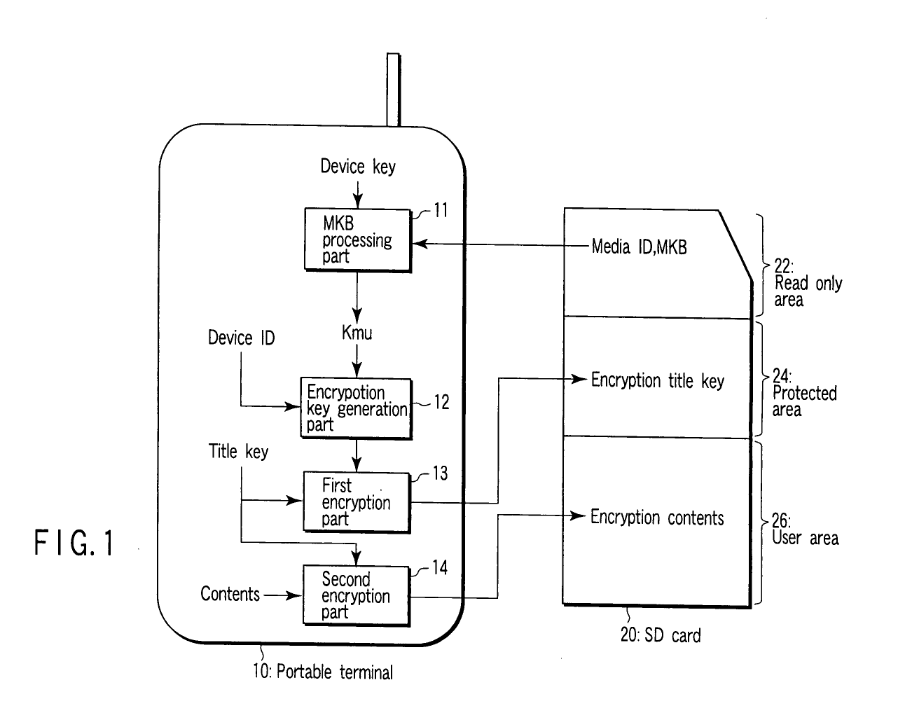

FIG. 1 is an exemplary view for explaining a schematic configuration and a flow of data to be protected by a CPRM for SD-Binding technique of a portable terminal regarding an embodiment of the present invention. In FIG. 1, a basic configuration of the portable terminal, for instance, a CPU, a keyboard, an LCD, etc., go same as those of a usual portable terminal, so that they will not be shown in FIG. 1 and will not be explained (and so forth).

A function of the CPRM for SD-Binding is a technique in which a CPRM technique is applied to an SD-Binding specification that is an application standard of an SD memory card. This technique stores information necessary for encryption in a concealment area when the portable terminal, by which the contents are downloaded, encrypts copyrighted contents to store them in the SD memory card. The contents are bound to a memory card, a device with the contents written therein, or a user. Even if the user wants to copy the encrypted contents to other SD memory card or to re-use them by other device, the other device cannot play the copied contents through a configuration other than the original configuration of the device by which they have downloaded.

A portable terminal 10 has an media key block (MKB) processing part 11, an encryption key generation part 12, a first encryption part 13, and a second encryption part 14.

The MKB processing part 11 retrieves a device key from the portable terminal 10, and also retrieves an MKB, described below in detail, from an SD memory card 20 to generate a media unique key (hereinafter referred to as Kmu).

The cryptographic key generation part 12 generates an encryption key from the Kmu generated from the MKB processing part 11 and a device ID of the portable terminal.

The first encryption part 13 encrypts a title key by using the encryption key generated from the encryption key generation part 12 to store the encrypted title key (hereinafter referred to as “encryption title key”) in the memory card 20.

The second encryption part 14 encrypts contents by using the title key to store the encrypted contents (hereinafter referred to as “encryption contents”) in the memory card 20.

The memory card 20 removable to the portable terminal 10 includes a read only area 22, a protected area 24 and a user area 26. The read only area 22 of the memory card 20 is an area, which is impossible to be made a change such as rewriting by the user, and in which the MKB to determine effectiveness of a media ID that is an identifier for media identification and the device key is stored. The protected area 24 is an area which can be accessed after mutual certification between the device and the SD memory card, and in which the title key and a rule added to contents are mainly stored. The user are 26 is a part in which the encrypted contents are mainly stored.

Operations of the portable terminal configured as mentioned above will be described.

At first, the MKB processing part 11 of the portable terminal 10 generates a Kmu proper to a medium from the device key of the portable terminal 10 and the MKB of the memory card 20. The Kmu is transmitted to the encryption key generation part 12. The encryption key generation part 12 generates the encryption key from the Kmu and the device ID of the portable terminal.

The first encryption part 13 encrypts the title key by use of the encryption key. The encryption title key is stored in the protected area 24. The second encryption part 14 encrypts the contents by using the title key. The encrypted contents are stored in the user area 26.

When calling the encrypted contents to play them, it is needed for the portable terminal 10 to refer to the encryption title key stored in the protected area 24 and decrypt the encrypted contents. Here, when another portable terminal 10 tries to play the encrypted contents, since another portable terminal has a different device ID of the portable terminal: therefore, the encryption title key cannot be generated by another portable terminal properly, then the encrypted contents are decrypted by the generated improper encryption title key. Therefore, another portable terminal cannot decrypt the encrypted contents to play them.

In the system shown in FIG. 1, however, it generates the encryption key by referring only to the device ID of the portable terminal, so that although the device ID of the portable terminals are unique to each portable terminal 10, if the device ID of the portable terminals have come out, the possibility of being easily hacked becomes large.

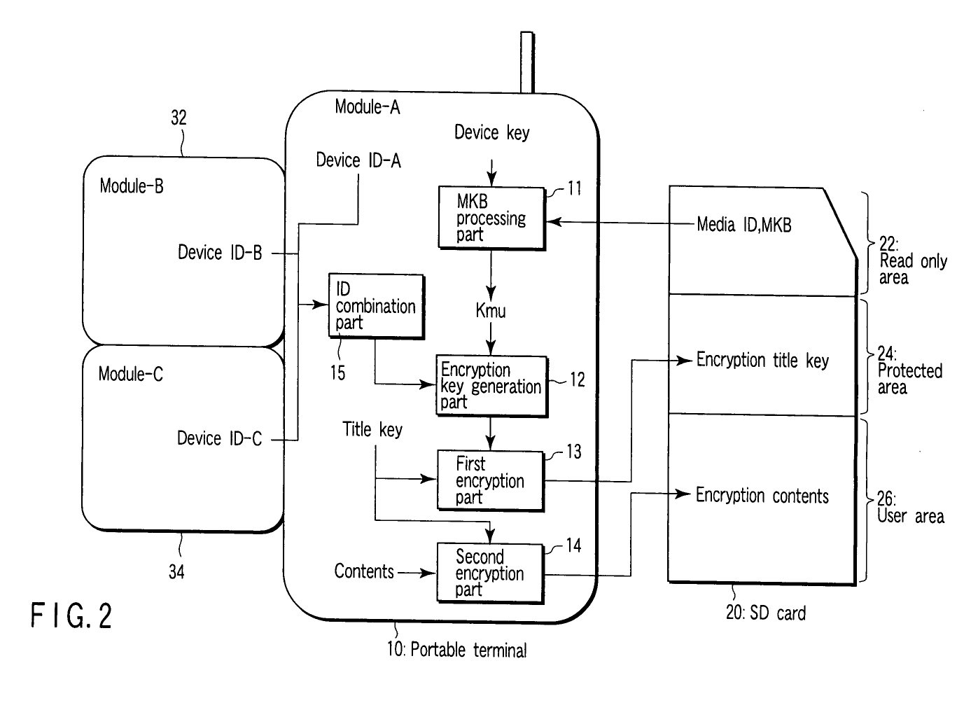

Accordingly, it becomes possible for a first embodiment of the present invention to protect copyright further strongly by generating the encryption key in combination with a plurality of device IDs. The first embodiment of the present invention will be explained with reference to FIG. 2. FIG. 2 is a view for explaining a schematic configuration and a data flow in the case of protection by a CPRM for SD-Binding technique of a portable terminal regarding the first embodiment of the invention. In FIG. 2, the same parts as those of FIG. 1 will be put the same reference symbols to omit those detailed explanations.

In FIG. 2, the man body of the portable terminal 10 is grasped as one module, the main body is referred to as a module A, and it is presumed that two modules (module-B 32 and module-C 34) are held onto the portable terminal 10. These held module-B 32 and module-C 34 may, as mentioned above, be any module as long as a module, such as an external display, a loud-speaker, a wireless LAN, a personal handy-phone system (PHS), a keyboard, a memory, removable to the portable terminal 10. It is assumed that the main body of the portable terminal 10 is treated as one module and it is not specifically distinguished from other additional modules attachable/detachable to/from the main body.

A different point between the configuration regarding the first embodiment in FIG. 2 and the configuration of the embodiment in FIG. 1 is a point of an addition of an ID combination part 15.

The ID combination part 15 performs a prescribed calculation by combining a device ID of a module A (hereinafter referred to as “Device ID-A”), a device ID of a module B (hereinafter referred to as “Device ID-B”), and a device ID of a module C (hereinafter referred to as “Device ID-C”) to output an ID corresponding to the device ID of the portable terminal shown in FIG. 1 (hereinafter referred to as “combination ID”). The encryption key generation part 12 then generates the encryption key from the Kmu and the combination ID. The flow after this goes same as that of FIG. 1, so that its explanation will be omitted.

In this case, a method for generating the combination ID may be obtained, for instance, by the following calculation expression:

device ID-A XOR device ID-B XOR device ID-C.

A calculation method is not limited to XOR (exclusive OR) and may by a calculation method of denial (NOT) and its combination, arithmetic operation (for instance, any one of addition, subtraction, multiplication and division) and their combination. The combination of the four rules of arithmetic operations and a logical calculation may be acceptable. Any calculation expression, for example, the following expressions may be usable:

device ID-A XOR device ID-B NOT device ID-C

device ID-A+device ID-B+device ID-C

device ID-A×device ID-B×device ID-C

device ID-A XOR device ID-B+device ID-C.

That is, a function, such as an operation expression in which the device ID-A, device ID-B, and device ID-C are input to output a result going with the inputs, may be acceptable.

When generating the encryption key, the first embodiment basically generates the combination ID by using the device IDs of all modules and generates the encryption key from the combination ID and the Kmu. Therefore, to read the encryption key, it is required to know the device IDs of all the modules. Thus, the portable terminal 10 can reduce the possibility of the hacking and its risk.

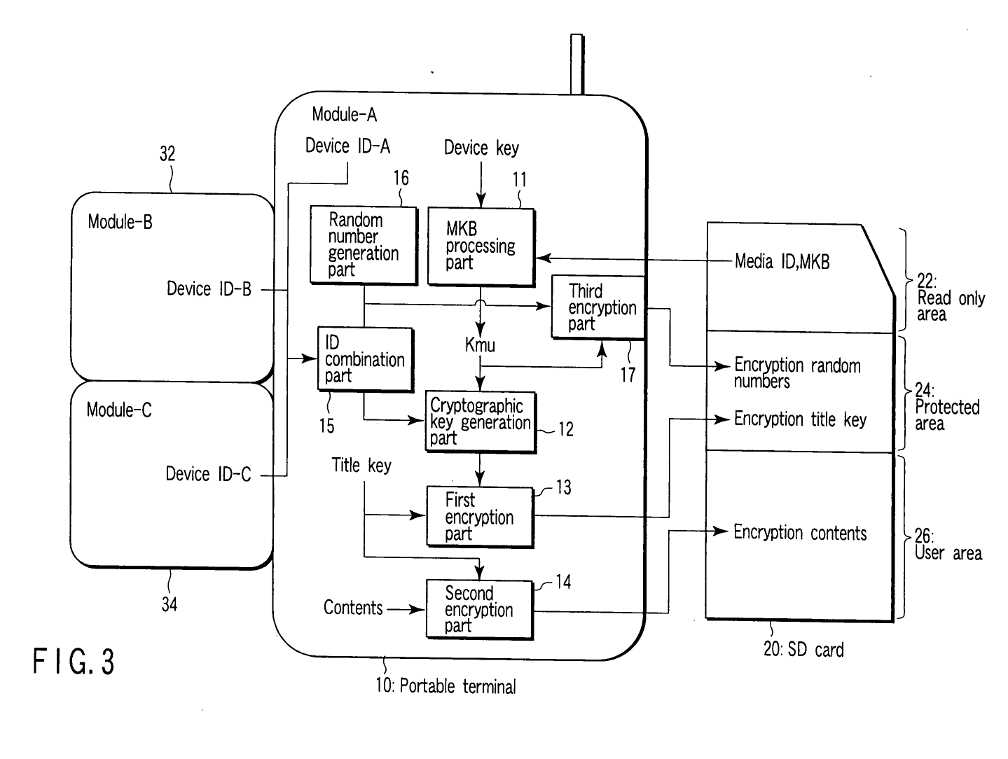

The second embodiment of the invention will be explained by referring to FIG. 3. FIG. 3 is a view for explaining a schematic configuration and a data flow in the case of protection by the CPRM for SD-Binding technique of a portable terminal regarding the second embodiment of the invention. In FIG. 3, the same parts as those of FIG. 1 and FIG. 2 will be designated by the same reference symbols to omit those detailed explanation.

In the portable terminal regarding the second embodiment shown in FIG. 3, a random number generation part 16 and a third encryption part 17 are added to the configuration of the first embodiment. Thereby, when the ID combination part 15 generates the combination ID, the combination part 15 decides the combination of the device IDs with random numbers to generate the combination ID. More specifically, the combination ID is generated as follows.

The random number generation part 16 of the portable terminal 10 generates the random numbers. At this time, it is supposed that processes relating to a combination method are determined in advance in accordance with the values of the random numbers. As for this processes, for instance, as for the combination ID to be output, when the random numbers 1 to 4 are generated, the combination ID may be calculated by the calculation as follows:

random number=1: device ID-A XOR device ID-B

random number=2: device ID-B XOR device ID-C

random number=3: device ID-A XOR device ID-C

random number=4: device ID-A XOR device ID-B XOR device ID-C.

That is, a function such as a calculation expression, in which the device ID-A, device ID-B, device ID-C, and the values of the random numbers are input, the process relating to the combination method is decided by the random numbers and from which a result from the process is output, my be usable. The generated random numbers are encrypted with the Kmu by the third encryption part 17 and managed in the protected area 24 in making pairs with encryption title keys. In decrypting the contents, the portable terminal 10 may obtain the combination method from the combination ID in use of the decrypted random numbers.

In the above-described second embodiment, in generating the encryption key the portable terminal 10 combines the device IDs of all the modules to generate the combination ID and generates the encryption key from the combination ID and the Kmu. Therefore, the same effect as that of the first embodiment may be obtained. Further, since a plurality of combinations of the device IDs have been decided at random, the portable terminal 10 cannot be hacked unless the combination method is known. The combinations varying for each content, even if one combination has been hacked, other combinations are not affected. Therefore, the second embodiment can further reduce the possibility of the hacking and its risk.

In the first and second embodiments, having generated the encryption keys by using all the device IDs, there is no need to use the device IDs for all the modules and the user may select the necessary modules, and the encryption keys may be generated only by the device IDs of a part of the modules.

In the second embodiment, having described that the calculation expression is XOR, NOT and the arithmetic calculation expression may be adopted as the calculation expression in the same way as the first embodiment. Further, the calculation expression may be changed by the values of the random numbers.

In the first and second embodiments, having decided the additional modules as two of module-B 32 and module-C 34, the additional module may be one and not less than 3. In this case, if only the module-B 32 is added, in the first embodiment, the portable terminal 10 computes the combination ID by calculating through the module-A and module-B. In the second embodiment, the calculation may be performed, for instance, as follows:

random number=1: device ID-A

random number=2: device ID-B

random number=3: device ID-A XOR device ID-B.

According to the present invention, generating the encryption key by combining a plurality of modules, nobody can hack the portable terminal without coming to know all the device IDs added to each module. Furthermore, having decided the plurality of combinations of the device IDs at random, anyone cannot hack the portable terminal unless it comes to know the combination method. Varying the combinations at every contents, even if one combination has been hacked, other combinations are not affected therefrom.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A portable terminal capable of encrypting a content and connectable to a module and removable memory card which stores an encrypted content, comprising:
an ID combination part configured to generate a combination ID by combining a device ID of the portable terminal and a device ID of at least the one module; and
an encryption key generation part configured to generate an encryption key by using the combination ID generated from the ID combination part.

2. The portable terminal according to claim 1, further comprising:
a first encryption part configured to encrypt a title key of the content by using the encryption key; and
a second encryption part configured to encrypt the content by using the title key.

3. The portable terminal according to claim 1, further comprising a random number generation part configured to generate a random number, wherein
the ID combination part combines device IDs in accordance with a value of the random number.

4. The portable terminal according to claim 3, wherein the ID combination part decides the device ID used for obtaining the combination ID in accordance with a value of the random number.

5. The portable terminal according to claim 3, wherein the ID combination part obtains the combination ID by using at least one calculation expression of a logical operation including XOR and NOT and of the four rules of arithmetic operations and by using a combination of the device IDs.

6. The portable terminal according to claim 2, further comprising a random number generation part configured to generate a random number, wherein
the ID combination part combines device IDs in accordance with a value of the random number.

7. The portable terminal according to claim 6, wherein the ID combination part decides the device ID used for obtaining the combination ID in accordance with a value of the random number.

8. The portable terminal according to claim 6, wherein the ID combination part obtains the combination ID by using at least one calculation expression of a logical operation including XOR and NOT and of the four rules of arithmetic operations and by using a combination of the device IDs.

9. The portable terminal according to claim 8, wherein the ID combination part decides the device ID used for obtaining the combination ID in accordance with a value of the random number.
